(19) United States
(12) Patent Application Publication
(10) Pub. No.: US 2010/0097445 A1
(43) Pub. Date: Apr. 22, 2010

(54) RESTAURANT TABLES AND ELECTRONIC MENU APPARATUS

(75) Inventors: Mika Hirama, Tokyo (JP); Shuichi Tsujimoto, Kanagawa (JP); Naoki Watanabe, Tokyo (JP); Masaki Narahashi, Tokyo (JP); Sou Miyazaki, Saitama (JP)

Correspondence Address: PATTERSON & SHERIDAN, L.L.P., 3040 POST OAK BOULEVARD, SUITE 1500, HOUSTON, TX, 77056, US

(73) Assignee: TOSHIBA TEC KABUSHIKI KAISHA, Tokyo (JP)

(21) Appl. No.: 12/575,140

(22) Filed: Oct. 7, 2009

(30) Foreign Application Priority Data
Oct. 10, 2008 (JP) 2008-264436

(51) Int. Cl. H04N 13/04

(52) U.S. Cl. 348/51; 348/E13.075

(57) ABSTRACT

A restaurant table for which seats are arranged includes, a top plate on which a dishes is set, and a display panel provided in the top plate, and configured to display a three-dimensional image of the dish to be stereoscopically viewable.

### CROSS-REFERENCE TO RELATED APPLICATIONS

This application is based upon and claims the benefit of priority from prior Japanese Patent Application No. 2008-264436, filed Oct. 10, 2008, the entire contents of which are incorporated herein by reference.

### BACKGROUND OF THE INVENTION

1. Field of the Invention

The present invention relates to a restaurant table and electronic menu apparatus using the table.

2. Description of the Related Art

Jpn. Pat. Appln. KOKAI Publication No. 09-288772 discloses an order system of a restaurant using a tabletop terminal.

In this system, a terminal provided with a display and input section is installed on each table of a restaurant. On the display, names of items listed in the menu, and menu data such as images and the like are displayed. The customer browses the menu data displayed on the display to find an item to be ordered. When an item to be ordered is decided on, the customer touches the order button of the input section in a state where the image and the like of the item are displayed on the display. Then, order data related to the item is transmitted to the kitchen terminal to be subjected to order receiving processing.

However, in the conventional tabletop terminal, images of items are displayed in two-dimensional images. The two-dimensional image is flat, and hence it is difficult for the customer to appreciate the nature of the volume of the food and drink. When the quantity of the served food and drink is less than the quantity visualized from an image displayed on the electronic menu apparatus, a complaint is made by the customer in some cases.

Further, the display is placed on the top plate of the table. This hinders the setting of the dishes or plates to be served. Further, the space for arrangement of the dishes and plates is also restricted.

### BRIEF SUMMARY OF THE INVENTION

The present invention has been contrived on the basis of these circumstances, and an object thereof is to provide a restaurant table, and electronic menu apparatus using the table which are configured to achieve the following objects I to III.

I. Accurately conveying the nature of the volume of food and drink to be served at a restaurant to the customer
II. Not hindering the setting of the dishes or plates
III. Not restricting the space for arrangement of the dishes or plates

According to one aspect of the present invention, a restaurant table for which seats are arranged includes, a top plate on which a dishes is set, and a display panel provided in the top plate, and configured to display a three-dimensional image of the dish to be stereoscopically viewable.

An electronic menu apparatus comprising, a restaurant table in which a display panel which displays a three-dimensional image to be stereoscopically viewable is provided in a top plate used to set a dish to be served, a list display control section which displays an item list of a menu on the display panel; and an image display control section which displays a three-dimensional image of an item selected from among items in the item list on the display panel.

Additional advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an overall configuration view of an electronic menu system which is an embodiment of the present invention.

FIG. 2 is a data format of a record to be stored in a category database managed by a database server of the electronic menu system.

FIG. 3 is a data format of a record to be stored in an item database managed by the database server.

FIG. 4 is a data format of a record to be stored in an image database managed by the database server.

FIG. 5 is a data format of a record to be stored in a screen database managed by the database server.

FIG. 6 is a block diagram showing the configuration of an electronic menu terminal of the electronic menu system.

FIG. 7 is a schematic view showing an example of attachment of a display panel provided to the electronic menu terminal to a restaurant table.

FIG. 8 is a perspective view showing an example of a restaurant table to which the display panels are attached.

FIG. 9 is a schematic view showing the transition of main screens displayed on the display panel.

FIG. 10 is one layout example of a guide screen displayed on the display panel.

FIG. 11 is one layout example of a category screen displayed on the display panel.

FIG. 12 is one layout example of an item overview screen displayed on the display panel.

FIG. 13 is one layout example of an item detail screen displayed on the display panel.

FIG. 14 is one layout example of an order confirmation screen displayed on the display panel.

FIG. 15 is one layout example of an order completion screen displayed on the display panel.

FIG. 16 is a flowchart showing a main information processing procedure to be executed by a CPU of the electronic menu terminal.

FIG. 17 is a flowchart specifically showing the procedure of the category selection processing in FIG. 16.

FIG. 18 is a flowchart specifically showing the procedure of the detail screen display processing in FIG. 17.

FIG. 19 is a flowchart specifically showing the processing procedure of the order confirmation screen display processing in FIG. 17 or 18.

### DETAILED DESCRIPTION OF THE INVENTION

This embodiment is of a case where the present invention is applied to an electronic menu terminal of an electronic menu system constructed in a restaurant.

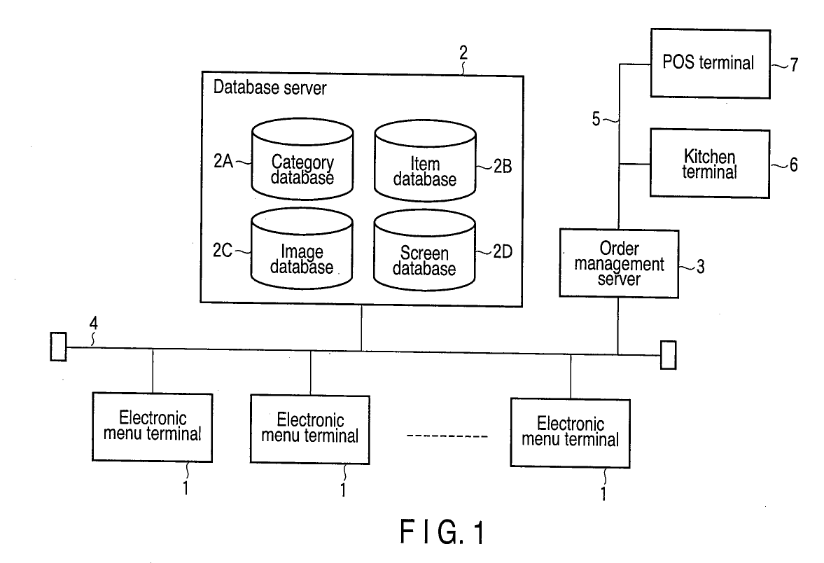

FIG. 1 is an overall configuration view of the electronic menu system. The electronic menu system is constituted of a plurality of electronic menu terminals 1, a database server 2, and order management server 3. Each of the electronic menu terminals 1 is connected to the database server 2 and order management server 3 through a local area network (LAN) 4.

The order management server 3 is a computer apparatus specialized in management of ordered data of customers. The order management server 3 connects a kitchen terminal 6 and point-of-sales (POS) terminal 7 to each other through a dedicated line. The kitchen terminal 6 creates data of cooking instruction to the kitchen on the basis of order data items of the customers, and displays the instruction data or produces printed output thereof. The POS terminal 7 calculates the price from the order data of a customer requesting the bill, and processes the payment data for the price to issue a receipt.

It should be noted that the line connecting the order management server 3, kitchen terminal 6, and POS terminal 7 to each other is not limited to the dedicated line 5. For example, the kitchen terminal 6 and POS terminal 7 may be connected to the LAN 4, and may transmit/receive data to/from the order management server 3 through the LAN 4.

The database server 2 is a computer apparatus specialized in management of various databases such as a category database 2A, item database 2B, image database 2C, screen database 2D, and the like.

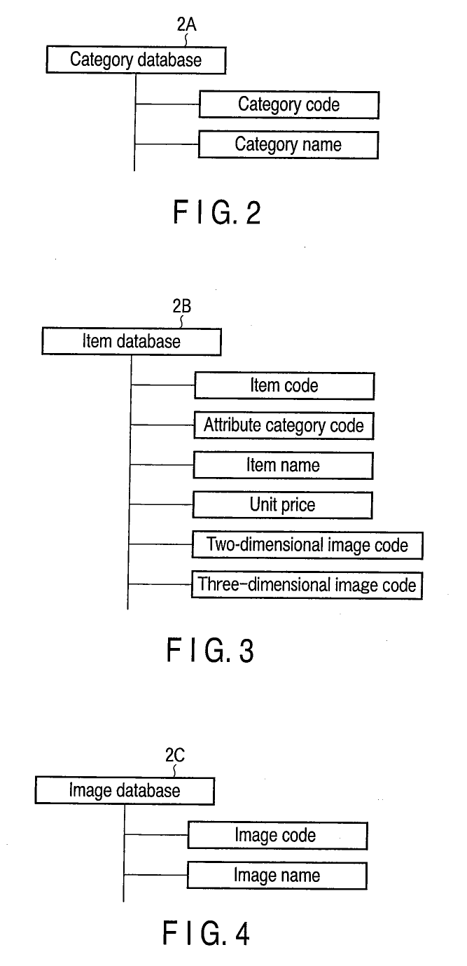

The category database 2A stores therein information on categories into which respective items of the menu are classified. FIG. 2 is a data format of a record to be stored in the category database 2A. The category database 2A stores therein records each including a category code and category name, the records being of a number corresponding to the number of categories. The category name is a name expressing a category such as hamburgers, pasta, curry, drink, dessert or the like. The category code is a proper code assigned to each category to recognize each category.

The item database 2B stores therein information on each item of the menu. FIG. 3 is a data format of a record to be stored in the item database 2B. The item database 2B stores therein records each including an item code, attribute category code, item name, unit price, two-dimensional image code, and three-dimensional image code, the records being of a number corresponding to the number of items.

The item code is a proper code assigned to each item to recognize each item of the menu. The attribute category code is a category code of a category to which an item belongs. The two-dimensional image code is a code used to recognize the two-dimensional image data of the item. The three-dimensional image code is a code used to recognize the three-dimensional image data of the item.

Three-dimensional image data is output to a stereoscopic display 17 to be described later, whereby an object to be displayed is displayed on the display surface of the display as a three-dimensional image with a three-dimensional expanse. At this time, various parameters are set in such a manner that the size of the three-dimensional image in the two-dimensional direction becomes a size substantially identical to the size of the actual item which is the object to be displayed. Further, the various parameters are set in such a manner that the size of the three-dimensional image in the height direction also gets as close as possible to the size of the actual item.

The image database 2C stores therein various image data. FIG. 4 is a data format of a record to be stored in the image database 2C. The image database 2C stores therein records each including an image code and image data, the records being of a number corresponding to the number of image data items. The image data includes two-dimensional image data, three-dimensional image data, and the like. The image code is a proper code assigned to the image data in order to recognize the corresponding image data.

Here, the item database 2B and image database 2C function as a menu data storage section configured to store menu data including image data for each item of the menu. It should be noted that in the item database 2B, image data may be stored in place of the image code. This realizes the menu data storage section by the item database 2B alone.

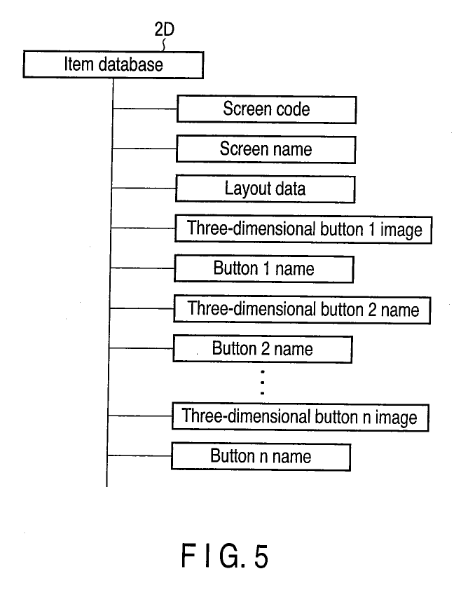

The screen database 2D stores therein various screen data. FIG. 5 is a data format of a record to be stored in the screen database 2D. The screen database 2D stores therein records each including a screen code, screen name, layout data, three-dimensional button image, and button name thereof, the records being of a number corresponding to the number of screen data items. The three-dimensional button image and button name form a pair, and a plurality of pairs are stored.

The screen code is a proper code assigned to each screen to recognize various screens displayed on a display panel of the electronic menu terminal 1. The screen name is a name set for the screen. The layout data is data indicating arrangement positions, sizes, colors, and the like of parts constituting the screen. The three-dimensional button image is image data of a stereoscopically viewable button part. The button name is a name to be displayed in the three-dimensional button image, the button name and three-dimensional button image forming a pair.

Next, the electronic menu terminal 1 will be described below. The electronic menu terminal 1 includes both a function of an electronic menu apparatus configured to electronically display an item list of a menu served to a customer in a restaurant, and function of an order input apparatus configured to convey information on an item selected from the menu and ordered by the customer to the order management server.

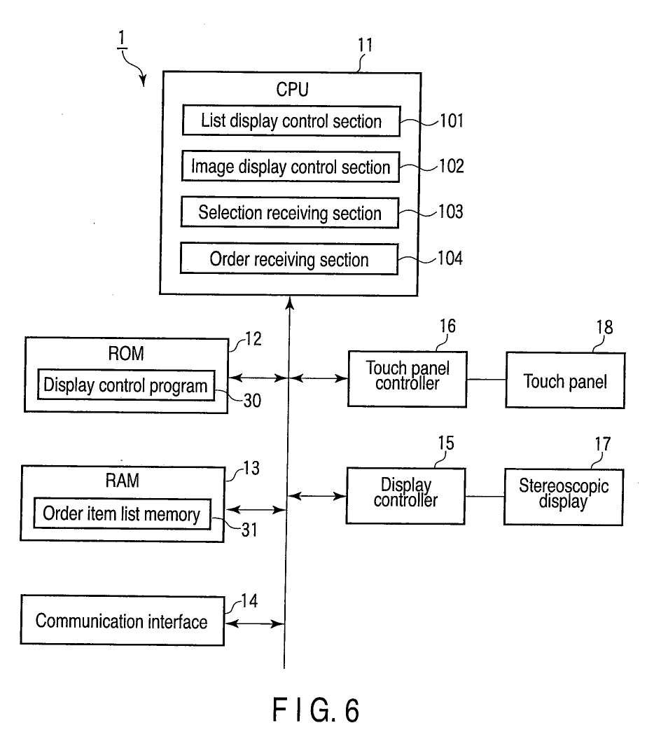

FIG. 6 is a block diagram of the electronic menu terminal 1. The electronic menu terminal 1 is a computer apparatus provided with a central processing unit (CPU) 11, read-only memory (ROM) 12, random access memory (RAM) 13, communication interface 14, display controller 15, and touch panel controller 16.

A LAN 4 is connected to the communication interface 14. The electronic menu terminal 1 can access the database server 2 through the communication interface 14, and acquire data of the databases 2A, 2B, 2C, and 2D. Further, the electronic menu terminal 1 can access the order management server 3 through the communication interface 14, and transmit the order data of the customer. The communication interface 14 constitutes a communication section.

The display controller 15 connects a stereoscopic display 17 thereto. The touch panel controller 16 connects a touch panel 18 thereto. The touch panel 18 is provided to be superposed on the stereoscopic display 17.

The stereoscopic display 17 is a display panel provided with a function of displaying a three-dimensional image to be stereoscopically viewable. In this embodiment, the naked-eye stereoscopic display not requiring special glasses is used. The naked-eye stereoscopic display includes a binocular display system (head tracking system, scanner backlight system, etc.) and multi-view display system (step barrier system, diagonal lenticular image system, etc.). In the present invention, the display system is not particularly limited. The stereoscopic display requiring glasses may also be used. However, in view of the use as the electronic menu terminal for a restaurant, the naked-eye stereoscopic display is preferable.

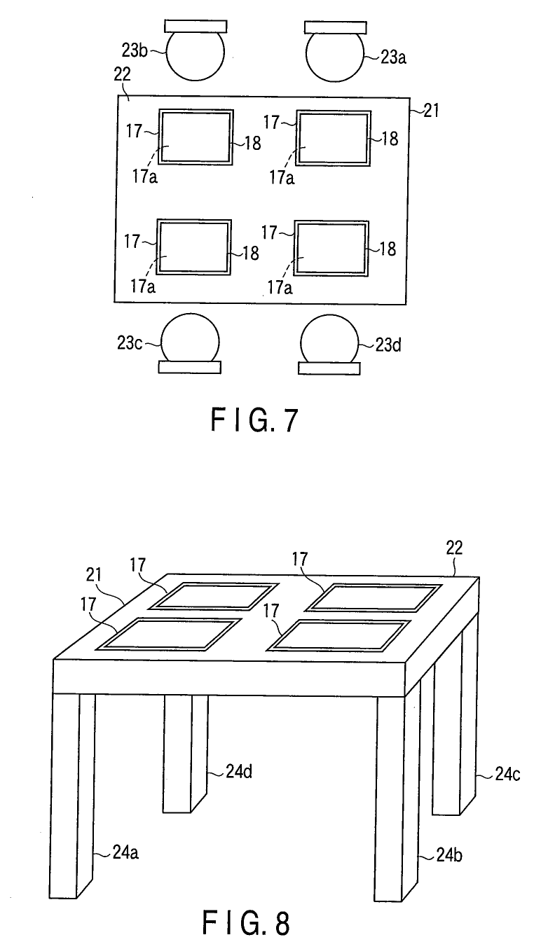

The stereoscopic display 17 is built into a top plate 22 of a restaurant table 21 as shown in FIG. 7. Further, the touch panel 18 is arranged on top of a screen 17a of the stereoscopic display 17. At this time, the screen 17a on which the touch panel 18 is arranged becomes substantially flush with the top surface of the top plate 22.

FIG. 7 is an example of attachment of the stereoscopic displays 17 to a restaurant table 21 for which two pairs of seats 23a and 23b, and 23c and 23d are prepared at two opposed sides of a substantially rectangular top plate 22. FIG. 8 is a perspective view of the table 21. As shown in FIGS. 7 and 8, the table 21 is provided with a top plate 22 on which dishes or plates are arranged to be served, and four legs 24a, 24b, 24c, and 24d supporting the top plate 22. Further, the stereoscopic display 17 is attached to a front part of each of the seats 23a to 23d.

The customer seated at the restaurant table 21 browses the images displayed on the stereoscopic display 17 in front of himself or herself, and appropriately touches the screen, whereby he or she can confirm the items to be served by the restaurant, and order the desired item.

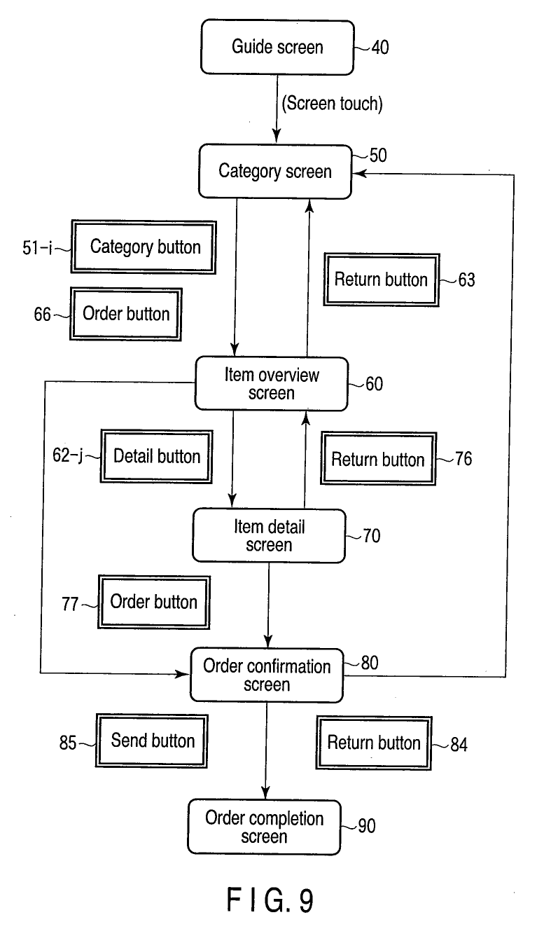

FIG. 9 is a transition view of screens to be displayed on the stereoscopic display 17 from the time when a customer confirms an item to the time when the order for the item is completed. The screens include a guide screen 40, category screen 50, item overview screen 60, item detail screen 70, order confirmation screen 80, and order completion screen 90.

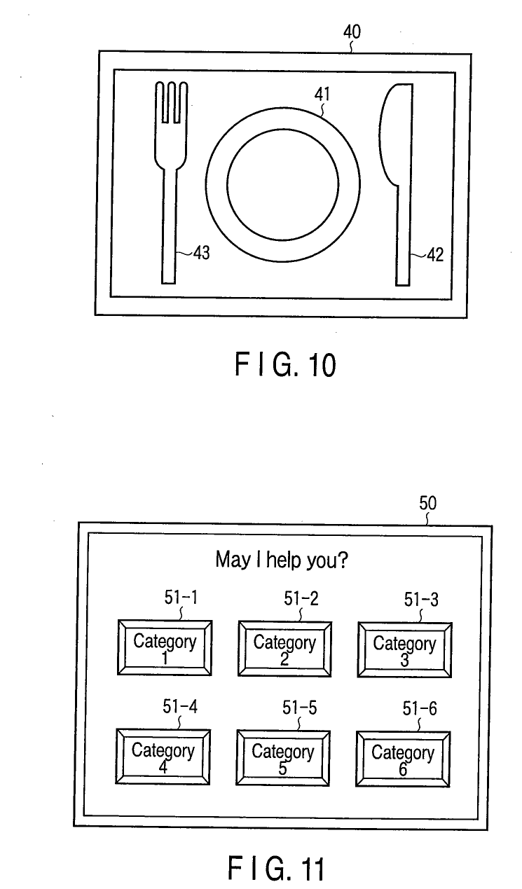

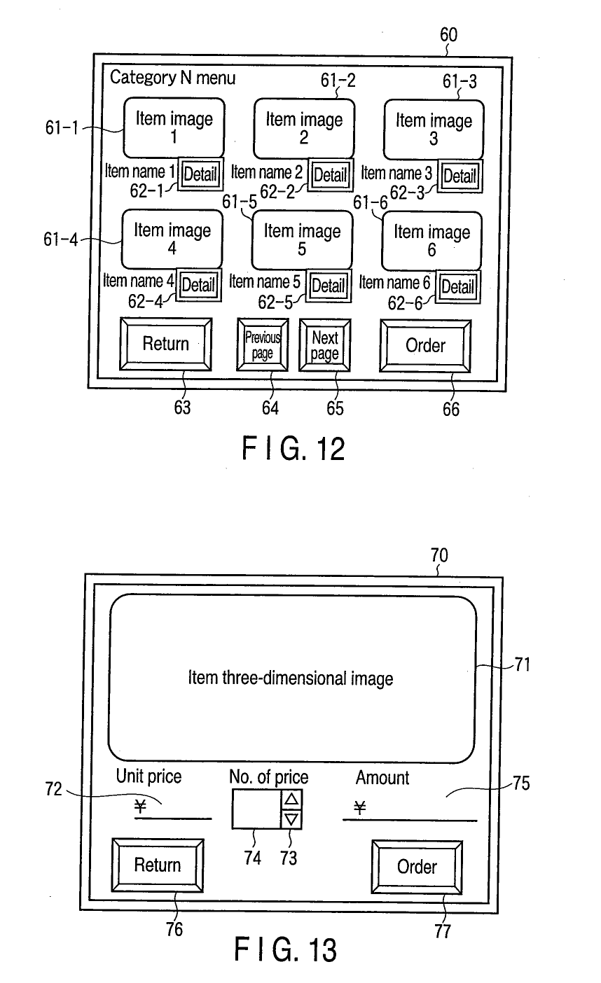

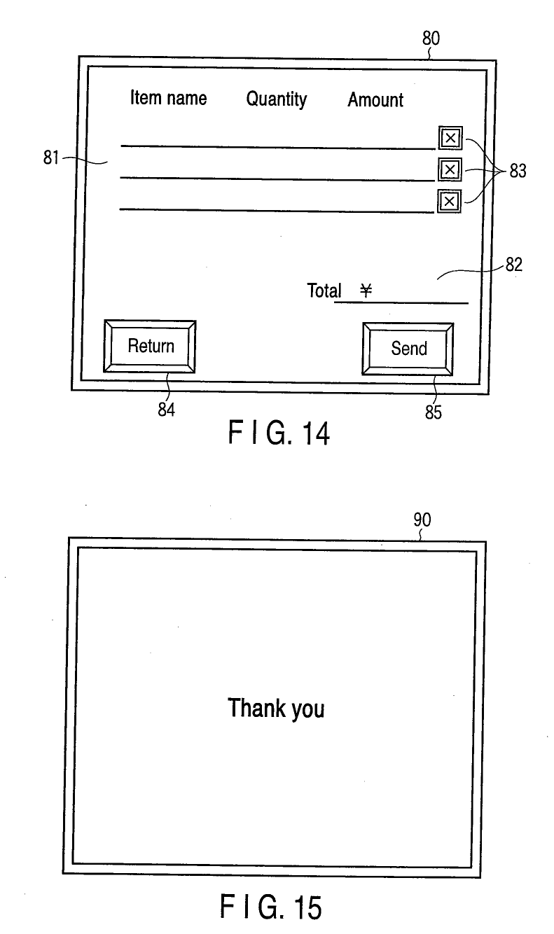

FIG. 10 is one layout example of the guide screen 40. FIG. 11 is one layout example of the category screen 50. FIG. 12 is one layout example of the item overview screen 60. FIG. 13 is one layout example of the item detail screen 70. FIG. 14 is one layout example of the order confirmation screen 80. FIG. 15 is one layout example of the order completion screen 90.

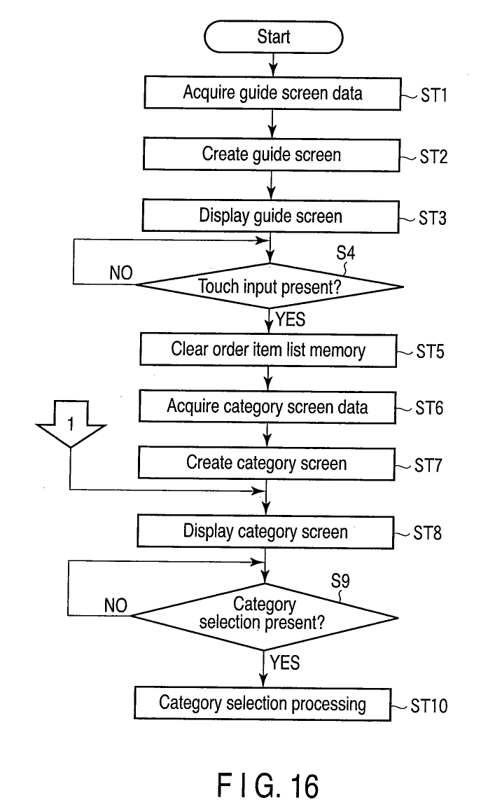

The CPU 11 controls the display processing of the respective screens 40 to 90 in accordance with a display control program 30 stored in a ROM 12. In order to realize this control, the CPU 11 includes functions of a list display control section 101, image display control section 102, selection receiving section 103, and order receiving section 104. Each function will be specifically described below by the flowcharts of FIGS. 16 to 19.

The operation procedure from the time when a customer confirms the item to the time when the customer completes the order, and the processing procedure of the CPU 11 for the operation of the customer will be described below by using the flowcharts of FIGS. 16 to 19.

The display control program 30 is started, and the CPU 11 of the electronic menu terminal 1 in the idle state starts the procedure shown in the flowchart of FIG. 16. First, the CPU 11 captures the record of the guide screen 40 from the screen database 2D (ST1). Further, the CPU 11 creates the guide screen 40 on the basis of the layout data of the record (ST2), and displays the screen 40 on the stereoscopic display 17 (ST3).

The guide screen 40 is a screen used to guide the user to a position at which the user can stereoscopically view a three-dimensional image to be displayed on the display 17. As shown in FIG. 10, on the guide screen 40, an image showing the tableware including a plate 41, knife 42, and fork 43 is displayed as a stereoscopically viewable three-dimensional image. The plate 41 is arranged substantially in the center of the screen. Further, the knife 42 is arranged on the right side of the plate 41, and fork 43 is arranged on the left side thereof.

The three-dimensional image to be displayed on the stereoscopic display 17 is not always stereoscopically viewable even when the display 17 is viewed from any direction, and there is a direction in which the image is stereoscopically viewable. In this embodiment, when a customer seated in one of the seats 23a to 23d of the table 21 assumes a proper posture in such a manner that the hands of the customer are placed at the positions of the knife 42 and fork 43 displayed on the display 17 in front of the customer, a three-dimensional image of an item displayed on the plate 41 becomes stereoscopically viewable. That is, the guide screen 40 functions as a guide configured to guide the customer to a position at which the customer can stereoscopically view the three-dimensional image to be displayed on the display 17.

Having displayed the guide screen 40, the CPU 11 waits for a signal to be input from the touch panel 18 as ST4.

A customer seated in the seat of the restaurant table 21 touches the screen of the stereoscopic display 17 arranged in front of the customer's seat before starting the order. When the screen is touched, a signal from the touch panel 18 is input to the touch panel controller 16. Upon detection of the signal from the touch panel 18, the CPU 11 clears the order item list memory 31 (ST5). The order item list memory 31 is formed in the RAM 13.

Subsequently, the CPU 11 captures a record of the category screen 50 from the screen database 2D (ST6). Further, on the basis of various setting information items of the record, the CPU 11 creates the category screen 50 (ST7), and displays the screen 50 on the stereoscopic display 17 (ST8).

The category screen 50 is a screen used to introduce categories into which respective items of the menu are classified to the customer, and receive selection of any one of the categories. As shown in FIG. 11, on the category screen 50, a plurality of (six in FIG. 11) category buttons 51 (51-1, 51-2, 51-3, 51-4, 51-5, and 51-6) prepared for each of the categories are displayed in the form of stereoscopically viewable three-dimensional buttons.

Having browsed the category screen 50, the customer touches any one category button 51-i (1≦I≦6) on which the desired category name is displayed to select the category.

The CPU 11 waits for a category to be selected (ST9). When any one category, button 51-i is touched, a signal is input from the touch panel 18 to the touch panel controller 16. Upon detection of the signal from the touch panel 18, the CPU 11 determines, on the basis of the signal, which category button 51-i has been touched, i.e., which category has been selected.

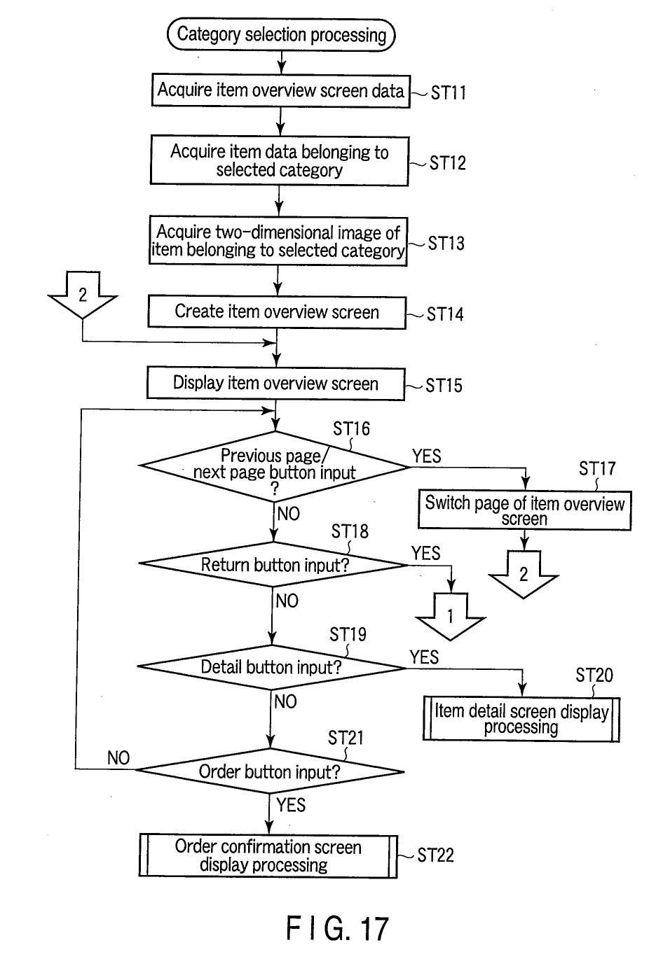

When the category is selected (YES in ST9), the CPU 11 starts the category selection processing specifically shown by the flowchart of FIG. 17 (ST10).

First, the CPU 11 captures the record of the item overview screen 60 from the screen database 2D (ST11). Further, the CPU 11 captures records of all the items belonging to the selected category from the item database 2B (ST12).

Then, the CPU 11 extracts the two-dimensional image code from the record of each item. Further, the CPU 11 captures all the records in each of which two-dimensional image data specified by the extracted two-dimensional image code is set from the image database 2C (ST13).

The CPU 11 creates the item overview screen 60 on the basis of various data of the records acquired in the processing of ST11 to ST13 (ST14), and displays the screen 60 on the stereoscopic display 17 (ST15: list display control section 101).

The item overview screen 60 is a screen used to introduce the items belonging to the selected category to the customer, and receive an order of any one item. As shown in FIG. 12, on the item overview screen 60, a plurality of (six in FIG. 12) item image display columns 61 (61-1, 61-2, 61-3, 61-4, 61-5, and 61-6) are formed. Further, detail buttons 62 (62-1, 62-2, 62-3, 62-4, 62-5, and 62-6) are displayed to correspond to the respective item image display columns 61. Further, a return button 63, previous page button 64, next page button 65, and order button 66 are displayed in the form of stereoscopically viewable three-dimensional buttons. These screen configuration elements 61 to 66 are included in the record of the item overview screen 60.

In the respective item image display columns 61, two-dimensional images of the items belonging to the selected category are displayed. Further, the names of the items are also displayed on the lower side of the images. The two-dimensional image is formed of the two-dimensional image data of the record captured from the image database 2C. The name of the item is recorded in the record captured from the item database 2B.

It should be noted that when the number of items belonging to the selected category exceeds the number of item image display columns 61, the item overview screen 60 is formed into a plurality of separate pages. Further, first, the first page is displayed.

After displaying the item overview screen 60, the CPU 11 waits for an input of any one of the buttons on the screen.

When although the item overview screen 60 has been browsed, no item which the customer wants to order is found, the customer touches the previous page button 64, next page button 65 or return button 63.

When the previous page button 64 or next page button 65 is touched (YES in ST16), the CPU 11 switches the page of the item overview screen (ST17). Further, the CPU 11 displays the item overview screen 60 the page of which has been switched on the stereoscopic display 17 (ST15). That is, when the previous page button 64 is touched, the item overview screen 60 is switched to the page preceding by one page, and when the next page button 65 is touched, the screen 60 is switched to the page succeeding by one page. It should be noted that when the current page is the first page, the previous page button 64 does not function. Likewise, when the current page is the last page, the next page button 65 does not function.

When the return button 63 is touched (YES in ST18), the CPU 11 returns the screen of the stereoscopic display 17 to the category screen 50 (ST8).

When the customer wants to confirm the current order contents, the customer touches the order button 66.

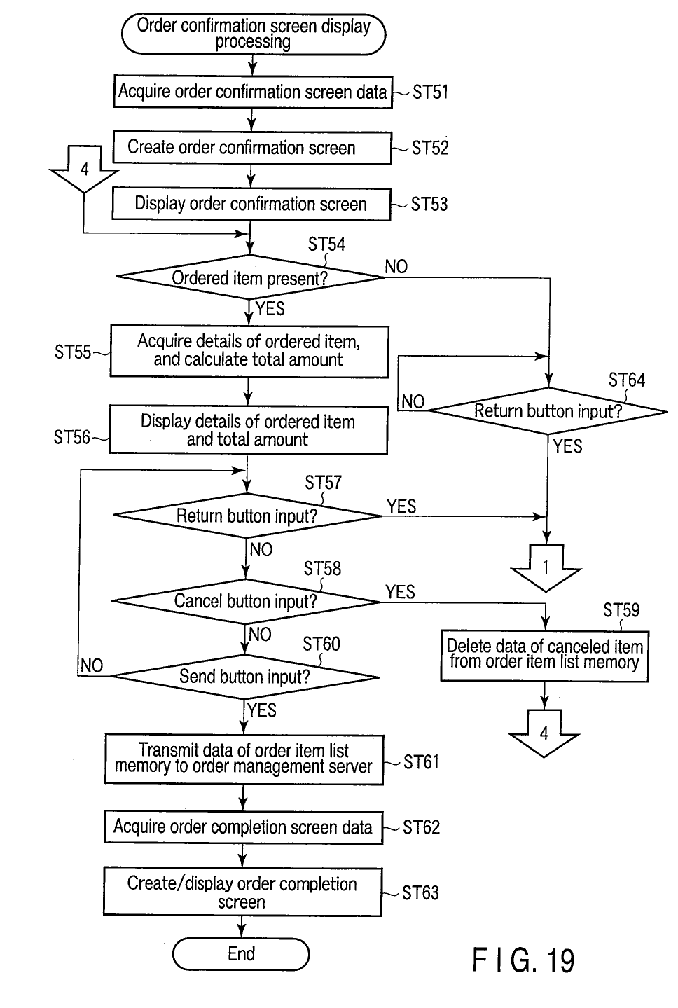

When the order button 66 is touched (YES in ST21), the CPU 11 executes the order confirmation screen display processing specifically shown in the flowchart of FIG. 19 (ST22). The order confirmation screen display processing will be described later.

When the item which the customer wants to order is found, the customer touches a detail button 62-j corresponding to the item image display column 61-j (1≦j≦6).

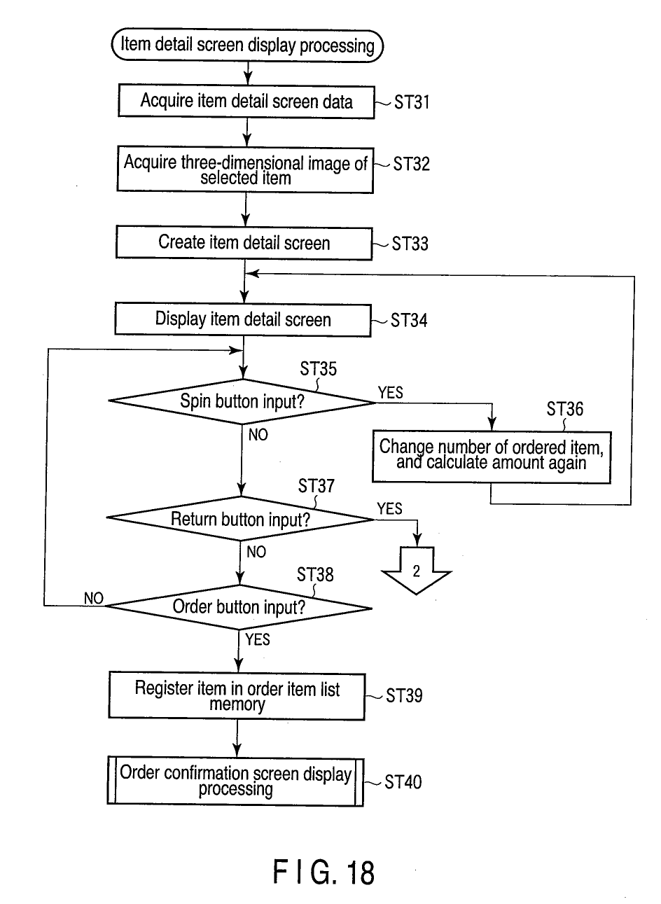

When the detail button 62-j is touched (YES in ST19), the CPU 11 executes the item detail screen display processing specifically shown in the flowchart of FIG. 18 (ST20: selection receiving section 103).

First, the CPU 11 captures the record of the item detail screen 70 from the screen database 2D (ST31). Then, the CPU 11 captures the record of the selected item from the item database 2B. The selected item is the item an image of which is displayed in the item image display column 61-j corresponding to the touch-operated detail button 62-j.

The CPU 11 extracts the three-dimensional image code from the record of the selected item. Further, the CPU 11 captures a record in which three-dimensional image data specified by the extracted three-dimensional image code is set (ST32).

The CPU 11 creates the item detail screen 70 on the basis of various data items of the records acquired in the processing of ST31 to ST32 (ST33), and displays the screen 70 on the stereoscopic display 17 (ST34: image display control section 102).

The item detail screen 70 is a screen used to introduce the detail information on the selected item to the customer, and receive an order. As shown in FIG. 13, on the item detail screen 70, the item detail image display column 71 is formed. Further, unit price column 72, edit field 74 with up-and-down spin buttons 73, amount display column 75, return button 76, and order button 77 are displayed thereon. Return button 76, and order button 77 are displayed in the form of stereoscopically viewable three-dimensional buttons. These screen configuration elements 71 to 77 are included in the record of the item detail screen 70.

In the item three-dimensional image display column 71, a three-dimensional image of the selected item is displayed. The three-dimensional image is formed by the three-dimensional image data of the record acquired from the image database 2C. Accordingly, the size of the three-dimensional image in the two-dimensional direction (X-Y direction) is substantially identical to the size of the actual item to be displayed. Further, the size thereof in the height direction (Z direction) is also made as close as possible to the size of the actual item.

As a result of this, in the item three-dimensional image display column 71, a three-dimensional image having substantially the size of the actual item is displayed to be stereoscopically viewable. Accordingly, it is possible for the customer viewing the item detail screen 60 to accurately appreciate the nature of the volume of the item from the three-dimensional image.

In the unit price display column 72, a unit price read from the record of the selected item is displayed. In the edit field 74, a default value “1” of the order quantity is displayed. In the amount display column 75, an amount obtained by multiplying the unit price of the selected item by the order quantity is displayed.

When the item detail screen 70 is browsed, and the number of the ordered items is to be changed, the customer touches the spin button 73. When the spin button 73 is touched (YES in ST35), the CPU 11 increases or decreases the order quantity in the edit field 74 by “1” at a time. Further, the CPU 11 calculates the amount again, and updates the value in the amount display column 75 (ST36).

When the selected item is to be ordered, the customer touches the order button 77. When the order button 77 is touched, the CPU 11 registers the record of the selected item in the order item list memory 31 as data of the ordered item. At this time, the order quantity and amount are also registered (ST39: order receiving section 104). After that, the CPU 11 executes the order confirmation screen display processing (ST40).

When the order of the selected item is to be canceled, the customer touches the return button 76. When the return button 76 is touched (ST37), the CPU 11 returns the screen of the stereoscopic display 17 to the item overview screen 60 without registering the data of the ordered item (ST15).

As described above, the customer who has located the item which they want to order on the item overview screen 60 touches a detail button 62-j corresponding to the item image display column 61-j a two-dimensional image of which is displayed. Then, the detail screen 70 of the selected item is displayed on the stereoscopic display 17. On the detail screen 70, a three-dimensional image of the selected item is displayed. Accordingly, the customer can visualize not only the detailed contents of the selected item, but also the actual nature of the volume thereof.

When the selected item is to be ordered, the customer touches the order button 77. Then, the order data of the selected item is registered in the order item list memory 31.

Next, the procedure of the order confirmation screen display processing to be executed in ST22 or ST40 will be described below with reference to the flowchart of FIG. 19.

In the state where the item overview screen 60, or item detail screen 70 is displayed, when the order button 66, or order button 77 is touched, the CPU 11 acquires the record of the order confirmation screen 80 from the screen database 2D (ST51). Further, the CPU 11 creates an order confirmation screen 80 on the basis of the data of this record (ST52), and displays the screen 80 on the stereoscopic display 17 (ST53).

The order confirmation screen 80 is a screen used to make the customer confirm the ordered contents. As shown in FIG. 14, on the order confirmation screen 80, the item name of the ordered item, details display column 81 constituted of the quantity and amount, and total amount display column 82 are formed. In the details display column 81, a cancel button 83 is formed for each details row. Further, a return button 84 and send button 85 are displayed as stereoscopically viewable three-dimensional buttons.

The CPU 11 searches the order item list memory 31 for the data of the ordered item to determine whether or not the data of the ordered item is registered therein (ST54). When the data is registered therein (YES in ST54), the CPU 11 acquires the name, order quantity, and amount of the ordered item from the registered data, and calculates the total amount (ST55). Further, the CPU 11 displays the name, order quantity, and amount of the ordered item in the details display column 81 of the order confirmation screen 80. Further, the CPU 11 displays the total amount in the total amount display column 82 (ST56).

The CPU 11 waits for any one of the cancel button 83, return button 84, and send button 85 to be input.

When the order confirmation screen 80 is browsed, and ordering is to be continued, the customer touches the return button 84. When the return button 84 is touched (YES in ST57), the CPU 11 returns the screen of the stereoscopic display 17 to the category screen 50 (ST8).

When the order is to be canceled, the customer touches a cancel button 83 corresponding to the row in which the details of the item to be canceled is displayed in the details display column 81. When the cancel button 83 is touched (YES in ST58), the CPU 11 deletes the registered data of the item for which a delete instruction has been issued from the order item list memory 31 (ST59). Thereafter, the CPU 11 returns to the processing of ST54.

When the order is to be determined, the customer touches the send button 85. When the send button 75 is touched (YES in ST60), the CPU 11 transmits the data of the ordered item registered in the order item list memory 31 to the order management server 3 (ST61).

Subsequently, the CPU 11 captures the record of the order completion screen 90 from the screen database 2D (ST62). Further, the CPU 11 creates the order completion screen 90 on the basis of the data of the record, and displays the screen 90 on the stereoscopic display 17 (ST63).

By the procedure described above, the order of one customer is completed. Thereafter, the CPU 11 returns the screen of the stereoscopic display 17 to the guide screen 40. The electronic menu terminal 1 is brought into the idle state.

It should be noted that when, as a result of searching the order item list memory 31 for the data of the ordered item, the data of the ordered item is not registered in the memory 31 (NO in ST54), the CPU 11 waits for the return button 84 to be input (ST64). When the return button 84 is touched (YES in ST64), the CPU 11 returns the screen of the stereoscopic display 17 to the category screen 50 (ST8).

As described above, according to this embodiment, it is possible for the customer seated in one of the seats 23a to 23d of the restaurant table 21 to visualize the nature of the volume of an item from the three-dimensional image thereof in a substantially accurate manner before ordering the item of the menu. Accordingly, the customer can securely order the item in a quantity which the customer wants to take. As a result of this, the quantity of the served item is neither less than nor more than that visualized by the customer, and the level of the customer-satisfaction can be enhanced.

Furthermore, the screen 17a of the stereoscopic display 17 is flush with the top surface of the top plate 22 constituting the restaurant table 21. Accordingly, although the actual dishes of the ordered items are arranged on the top plate 22 of the table 21, the displays 17 never hinder the setting of the dishes. That is, all the space on the top plate 22 can be effectively utilized as the space for setting the dishes.

Further, the data of the item ordered by the customer by himself or by herself from the electronic menu terminal 1 is directly transmitted to the order management server 3. Further, the order data is used as a cooking instruction to the kitchen terminal 6, and is used for the account processing at the POS terminal 7. Accordingly, by employing the electronic menu terminal 1 of this embodiment using the restaurant table 21, it is possible to construct a self-ordering restaurant system providing a very high degree of satisfaction to both the customer side and restaurant side.

It should be noted that the present invention is not limited to the above-mentioned embodiment as it is. In the implementation stage, the constituent element of the invention can be modified and embodied within the scope not deviating from the gist of the invention.

For example, in the above embodiment, the guide screen 40 is shown as an example of a start screen of the electronic menu terminal 1 in the idle state. However, the start screen is not necessarily limited to the guide screen 40. Even when a start screen other than the guide screen 40 is used, it is possible to sufficiently achieve the objects I, II, and III described previously.

However, by using the guide screen 40 as the start screen, it is possible to guide the customer who has seated at the restaurant table 21 to the position at which the three-dimensional image to be displayed on the display 17 can be stereoscopically viewed.

It should be noted that the images to be displayed on the guide screen 40 are not limited to the images of FIG. 10. In short, it is sufficient if the images to be displayed on the guide screen 40 are images which can guide the customer who has seated at the restaurant table 21 to the position at which the three-dimensional image to be displayed on the display 17 can be stereoscopically viewed. Further, a message, for example, “Please view the screen from this position” may be displayed on the display 17 or top plate 22.

Further, in the above embodiment, it has been described that after the order has been completed, the screen of the display 17 is returned to the guide screen 40. However, a screen other than the guide screen 40, for example, a screen on which an image suitable for the ordered dish is displayed may be displayed.

Further, in the above embodiment, the three-dimensional image of the item to be displayed on the stereoscopic display is made substantially the exact size. However, the size is not necessarily the exact size. Even when only the size in the two-dimensional direction is made substantially identical to the size of the actual item, and the height is made different from the exact size, it is possible to make the customer visualize the nature of the substantially accurate volume of the cooked item.

Further, in the above embodiment, when the detail button 62 of the item overview screen 60 is touched (ST19), the flow is shifted to the item detail screen display processing. However, alternatively, when the image displayed in the item image display column 61 is touched, the flow may be shifted to the item detail screen display processing. This makes it possible to omit the detail buttons 62 from the item overview screen 60.

Further, in the above embodiment, the touch panel 18 is shown as an input device of the electronic menu terminal 1. However, the input device is not limited to the touch panel. For example, a pointing device such as a mouse, keyboard or the like can be used. In this case, the screen 17a of the stereoscopic display 17 becomes substantially flush with the top surface of the top plate 22.

Further, in the above embodiment, an electronic menu terminal 1 is provided to each of the seats 23a to 23d of the restaurant table 21. However, one electronic menu terminal 1 may be provided to each restaurant table 21, and a plurality of customers seated at the same table 21 may share the use of the one electronic menu terminal 1 with each other.

However, by providing the electronic menu terminals 1 at positions in front of the seats 23a to 23d of the top plate 22 in a one-to-one correspondence with the seats 23a to 23d, the merit of making it easily possible to determine which of the customers seated at the table 21 has ordered an item of interest is obtained.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A restaurant table for which seats are arranged comprising:
a top plate on which a dishes is set; and
a display panel provided in the top plate, and configured to display a three-dimensional image of the dish to be stereoscopically viewable.

2. The restaurant table according to claim 1, wherein
the display panel is arranged at a position in front of the seat of the top panel in a one-to-one correspondence with the seat.

3. The restaurant table according to claim 1, wherein
a screen of the display panel is flush with a top surface of the top plate.

4. The restaurant table according to claim 1 further comprising:
a touch panel provided on top of the screen of the display panel.

5. The restaurant table according to claim 4, wherein
the display panel is arranged at a position in front of the seat of the top panel in a one-to-one correspondence with the seat.

6. The restaurant table according to claim 4, wherein
the surface of the display panel on which the touch panel is superposed is flush with the top surface of the top plate.

7. The restaurant table according to claim 1 further comprising:
a guide configured to guide a user to a position at which the user can stereoscopically view a three-dimensional image to be displayed on the display panel.

7. The restaurant table according to claim 5, wherein
the guide is an image of tableware displayed on the display panel.

8. The restaurant table according to claim 4 further comprising a guide configured to guide a user to a position at which the user can stereoscopically view a three-dimensional image to be displayed on the display panel.

9. The restaurant table according to claim 8, wherein
the guide is an image of tableware displayed on the display panel.

10. An electronic menu apparatus comprising:
a restaurant table in which a display panel configured to display a three-dimensional image to be stereoscopically viewable is provided in a top plate used to set a dish to be served;
a list display control section configured to display an item list of a menu on the display panel; and
an image display control section configured to display a three-dimensional image of an item selected from among items in the item list on the display panel.

11. The electronic menu apparatus according to claim 10, wherein
the list display control section displays two-dimensional images of respective items on the display panel in a list form.

12. The electronic menu apparatus according to claim 11 further comprising:
a touch panel provided on top of a screen of the display panel.

13. The electronic menu apparatus according to claim 12 further comprising:
a selection receiving section configured to specify an item selected from among items two-dimensional images of which are displayed on the display panel by a touch operation as a selected item, wherein
the image display control section displays a three-dimensional image of the selected item specified by the selection receiving section on the display panel.

14. The electronic menu apparatus according to claim 13, wherein
the three-dimensional image of the selected item is of substantially the exact size of the dish which is the selected item.

15. The electronic menu apparatus according to claim 13, wherein
the image display control section displays the three-dimensional image of the selected item specified by the selection receiving section on the display panel together with an order button configured to receive an order of the selected item.

16. The electronic menu apparatus according to claim 15 further comprising:
an order receiving section configured to receive an order of the selected item when the order button is touch-input.

17. The electronic menu apparatus according to claim 16 further comprising:
a communication section configured to transmit information on the selected item received by the order receiving section to an external apparatus.

18. The electronic menu apparatus according to claim 14, wherein
the image display control section displays the three-dimensional image of the selected item specified by the selection receiving section on the display panel together with an order button configured to receive an order of the selected item.

19. The electronic menu apparatus according to claim 18 further comprising:
an order receiving section configured to receive an order of the selected item when the order button is touch-input.

20. The electronic menu apparatus according to claim 19 further comprising:
a communication section configured to transmit information on the selected item received by the order receiving section to an external apparatus.
